(19) United States
(12) Patent Application Publication
(10) Pub. No.: US 2003/0236102 A1
(43) Pub. Date: Dec. 25, 2003

(54) Electronic apparatus

(75) Inventors: Osamu Kawai, Kawasaki (JP); Satoshi Watanabe, Kawasaki (JP); Shigeo Iriguchi, Kawasaki (JP); Takeshi Okazaki, Kawasaki (JP); Masayuki Ozawa, Kawasaki (JP); Akio Munakata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/453,661

(22) Filed: Jun. 4, 2003

(30) Foreign Application Priority Data
Jun. 19, 2002 (JP) 2002-179138

(51) Int. Cl. H04M 1/00

(52) U.S. Cl. 455/550.1; 455/566; 455/575.8

(57) ABSTRACT

A portable electronic apparatus includes a display part that displays information, and an approximately pipe-shaped protective part, provided around and thicker than the display part, which protects the display part by positioning the display part at a depressed portion from the protective part.

### BACKGROUND OF THE INVENTION

The present invention relates generally to electronic apparatuses, and more particularly to a portable electronic apparatus having a display part such as a liquid crystal display (“LCD”). The present invention is suitable, for example, for a WebPAD. The “WebPAD”, as used herein, means an LCD-incorporated radio information terminal that serves as a portable web access tool. Of course, the inventive portable electronic apparatus is not limited to WebPAD, and covers a laptop personal computer (“PC” hereinafter), a game machine, a personal digital assistant (“PDA”), a portable television and the like.

The recent development of electronic apparatuses have required smaller, thinner and lighter portable terminals, such as a cellular phone and PDA, to enhance portability. At the same time, portable terminals have been required to be multifunctional to reflect users' preferences.

For example, the recent development of the Internet has demanded accesses to the Internet not only from PCs, but also from cellular phones and other electronic apparatuses. Thus, portable radio information terminals called WebPADs have recently been developed, which includes an LCD for displaying web information and a radio communication unit including an antenna for accessing the Internet.

However, a pursuit of miniaturization, low profile and lightweight property for the portability would lower the impact resistance property, thereby easily damaging inner electronic circuits as a result of a drop etc. In particular, the LCD in the WebPAD is generally larger than a display in a cellular phone and thus fragile. In addition, the conventional WebPAD in pursuit of the low profile has a relatively large LCD with the entire surface relatively flat. Thus, a user cannot easily hold the device securely, and the device easily slips and drops from user's hands with poor portability.

An attachment of a functional expansion member to a portable terminal in pursuit of multi-functionality often exposes the functional expansion member on a surface of the portable terminal, causing damages and losses. For example, when the WebPAD is provided with an antenna exposing to the outside for better sensitivity, instead of an inner antenna, the antenna bends and breaks against an external member when the WebPAD is not used. When the LCD serves as a touch panel for inputting information using a pen and a fixing part for fixing the pen is provided at a side of a housing of the LCD, the pen bends and breaks against an external member when the WebPAD is not used.

### BRIEF SUMMARY OF THE INVENTION

Accordingly, it is an exemplified object of the present invention to provide a portable electronic apparatus in pursuit of miniaturization, low profile, lightweight property, and multi-functionality as well as improved portability and shock resistance.

In order to achieve the above object, a portable electronic apparatus of one aspect of the present invention includes a display part for displaying information, and an approximately pipe-shaped protective part, provided around and thicker than the display part, for protecting the display part by positioning the display part at a depressed portion from the protective part. This electronic apparatus includes the display part and the protective part, and forms a convex and concave that serve as a grip, enhancing portability. In addition, this electronic apparatus places the display part at a depressed portion from the protective part and thus improves the impact resistance, whereby the display part may not collide directly with the floor when the electronic apparatus drops on the floor or the like. The pipe shape facilitates gripping and enhances the portability. A curved surface of the pipe shape would serve to disperse the impact.

A portable electronic apparatus of another aspect of the present invention includes a display part for displaying information, a protective part, provided around and thicker than the display part, for protecting the display part by positioning the display part at a depressed portion from the protective part, and a functional expansion unit, accommodated in the protective part, for expanding a function of the electronic apparatus. This electronic apparatus includes the display part and the protective part and forms a concave that serves as a grip and enhances portability. In addition, this electronic apparatus places the display part at a depressed portion from the protective part and thus improves the impact resistance, whereby the display part may not collide directly with the floor when the electronic apparatus drops on the floor or the like. The protective part accommodates the functional expansion unit and is made multifunctional, while the functional expansion unit is prevented from exposing to the outside and getting damaged or lost.

The electronic apparatus may further include a shock absorbing member, provided between the display part and the protective part, for reducing a shock applied to the display part. The shock absorbing member, such as rubber, may enhance the impact resistance.

The protective part may include a base made of a first material, and a grip made of a second material that has a thermal conductivity lower than the first material. Use of the second material that has a thermal conductivity lower than the first material for the grip would prevent low-temperature burn. The first material may include magnesium, which has such high strength that the electronic apparatus may be made small, thin and lightweight. The second material includes resin, which prevents low-temperature burn as well as enhancing the slip resistance, improving the portability.

The display part may be a LCD having a thickness of about 15 to 20 mm, and fixed onto the protective part so that a difference of height from about 3 to 5 mm is formed in a direction perpendicular to the display part. This difference of height would improve the impact resistance. The weight of the electronic apparatus may be, for example, 700 g to 1,000 g. The protective part may have a pipe shape. The pipe shape facilitates gripping and enhances the portability. A curved surface of the pipe shape would serve to disperse the impact.

The functional expansion unit may include a radio communication part. The radio communication part includes an antenna, radio LAN card, bluetooth module, etc. for connecting the apparatus to the Internet, thereby preventing the antenna etc. from getting damaged and lost.

The functional expansion unit may include another display part for indicating an operational status of the electronic apparatus. For example, the other display part is LEDs for indicating a battery volume, a connection status to the external power source, a radio communication status, an access status to the memory, and an error of the electronic apparatus. The functional expansion unit may include a battery as a power source of the electronic apparatus. The battery may be a rechargeable secondary battery, and the electronic apparatus may include a connection part connectible to a charger to charge the battery.

The functional expansion unit includes an electronic imaging part (for example, a USB digital camera) for imaging a subject as digital information. The function expansion part may serve as a telephone. Such a telephone serves, for example, as an IP telephone. The functional expansion unit may serve as an electronic imaging part and a telephone so as to enable the electronic apparatus to serve as a videophone.

The functional expansion unit may include a reset switch for restart the electronic apparatus, a power switch to power on and off the power of the electronic apparatus, a speaker, and an USP port connectible to a functional expansion apparatus for expanding a function of the electronic apparatus. The functional expansion unit may include may include a pen for inputting information into the electronic apparatus through the display part and its accommodation part, a port that may communicate with an Ir receiver part (for example, a wireless keyboard or remote controller of a TV), a port for infrared data transmissions, and a connector connectible to a head phone. The functional expansion unit may include a radiator part, for example, a fan, for radiating the electronic apparatus. The display part may include an LCD, and the functional expansion unit may include an inverter as a backlight of the LCD.

The functional expansion unit includes a stand for inclining and placing the display part on a desk. Thereby, the electronic apparatus may be suitable for use on the desk. The stand may be provided rotatable relative to the protective part and the electronic apparatus may further include a holder for engaging with and fixing the stand, thereby fixing the inclination posture of the display part. The stand may be provided foldable relative to the protective part, and the electronic apparatus may further include a lock part for fixing the stand folded, thereby the stand is folded when it is unused and the lock part prevents its unfolding, thus preventing the stand from contacting the external member and bending. Preferably, the stand folded is placed partially on the display part, and the height of the stand viewed from the display part is lower than the protective part. Thereby, the stand does not prevent the electronic apparatus from being made thin.

Other objects and further features of the present invention will become readily apparent from the following description of the embodiments with reference to accompanying drawings.

### BRIEF DESCRIPTION OF THE DRAWINGS

FIG. 1A is a perspective overview of an electronic apparatus (or WebPAD) of one embodiment according to the present invention, and FIG. 1B is an exaggerated partial enlarged section at an end of the electronic apparatus shown in FIG. 1A.

FIG. 2 is an exploded perspective view of the electronic apparatus shown in FIG. 1.

FIG. 3A is a plane view of the electronic apparatus shown in FIG. 1, and FIG. 3B is its top view. FIG. 3C is its left side view, and FIG. 3D is its right side view.

FIG. 4 is a schematic perspective view for explaining a shock absorbing member that may be provided inside the pipe-shaped periphery in the electronic apparatus shown in FIG. 1.

FIG. 5A is a rear view of the electronic apparatus shown in FIG. 1, and FIG. 5B is a schematic plane view that is partially transparent and viewed from a direction A in FIG. SA. FIG. 5C is a schematic plane view that is partially transparent and viewed from a direction B in FIG. 5A.

FIGS. 6A and 6B are, respectively, schematic perspective and sectional views for explaining an engagement between a stand mechanism and a lock part shown in FIG. 5.

FIG. 7 is a schematic sectional view of the electronic apparatus placed on the desk via the stand mechanism shown in FIG. 5.

### DETAILED DESCRIPTION OF THE INVENTION

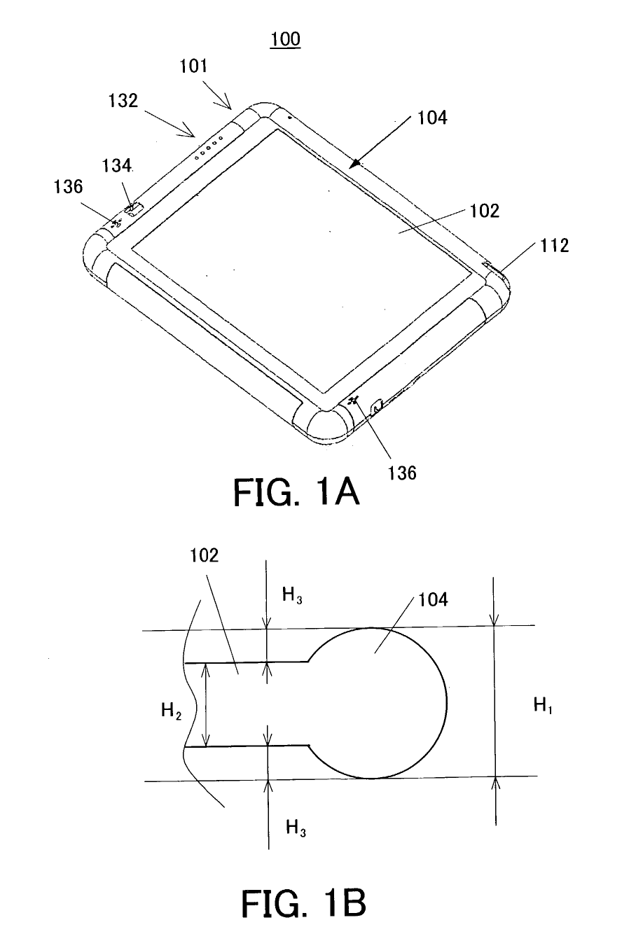

Referring now to accompanying drawings, a description will be given of a portable electronic apparatus 100 as one embodiment according to the present invention. The electronic apparatus 100 is implemented as WebPAD in this embodiment. Here, FIG. 1A is a perspective overview of the WebPAD 100, and FIG. 1B is an exaggerated partial enlarged section at an end of the WebPAD 100 shown in FIG. 1A.

The “portable electronic apparatus” includes PDAs, handheld PCs, palm-sized PCs, wearable computers, portable hardware, and portable terminals, and its size covers A4, B5, sub-notebook, mini-notebook and other sizes. The portable electronic apparatus excludes one which does not attempt portable use, such as an automobile navigation system even if it is small.

The WebPAD 100 includes a housing 101. The housing 101 is indented at its center part 102 from the periphery 104. As described later, the center part 102 includes a fragile display part, such as a LCD, and the periphery 104 serves as a protective part for protecting the center part 102. In other words, the center part 102 is thinner than, intended from, and thus protected by the periphery 104. The height H₁ of the periphery 104 is, for example, 18 to 25 mm, and the height H₂ of the center part 102 is, for example, 15 to 20 mm. The center part 102 is located at a position at a distance H₃, e.g., about 3 to 5 mm, from an end of the periphery 104. Thus, the WebPAD 100 is so configured that the center part 102 does not collide directly with the floor etc. when the WebPAD 100 drops on the floor etc. by indenting the center part 102 relative to the periphery 104, enhancing the impact resistance. The weight of the electronic apparatus is, for example, 700 g to 1 kg, realizing the lightweight property.

The center part 102 and periphery 104 form a concave and convex on the surface of the electronic apparatus 100, facilitate gripping, and improve the portability. On the other hand, the conventional electronic apparatus has such a flat surface, which easily slips from a user's fingers and drops to get damaged, that the electronic apparatus does not have satisfactory portability. However, the inventive electronic apparatus 100 has a concave and convex surface and thus improved the portability. In particular, the periphery 104 has an approximately pipe shape that facilitates gripping and enhances the portability, and a curved surface of the pipe shape would serve to disperse the impact.

The periphery 104 also serves as an accommodation part for accommodating a functional expansion unit that functionally expands the electronic apparatus 100, as described later, enhancing the multi-functionality of the electronic apparatus 100, and as well as preventing the functional expansion unit from exposing to the outside and getting damaged and lost.

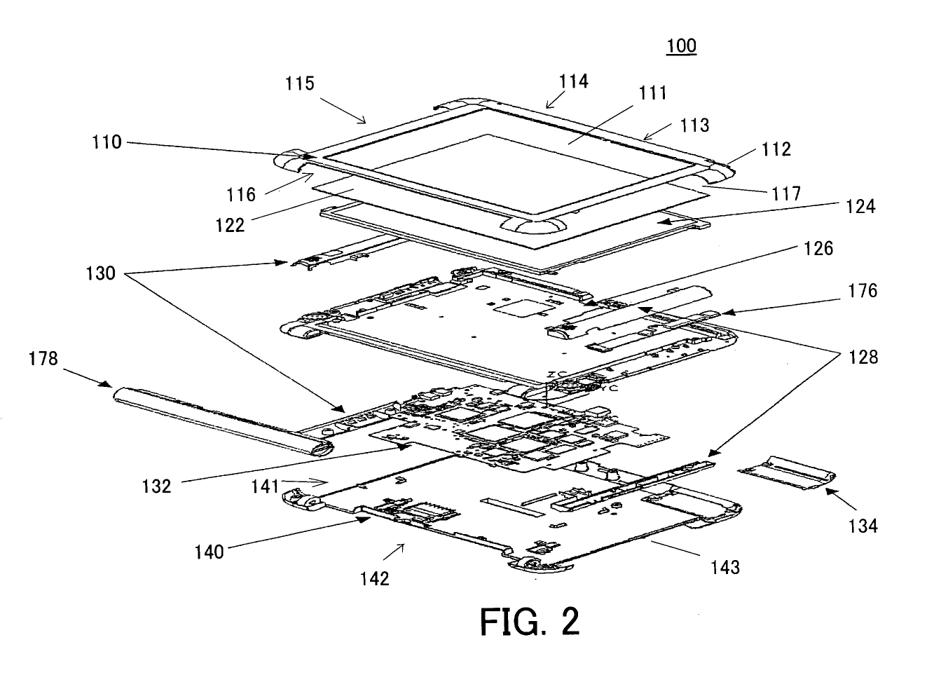

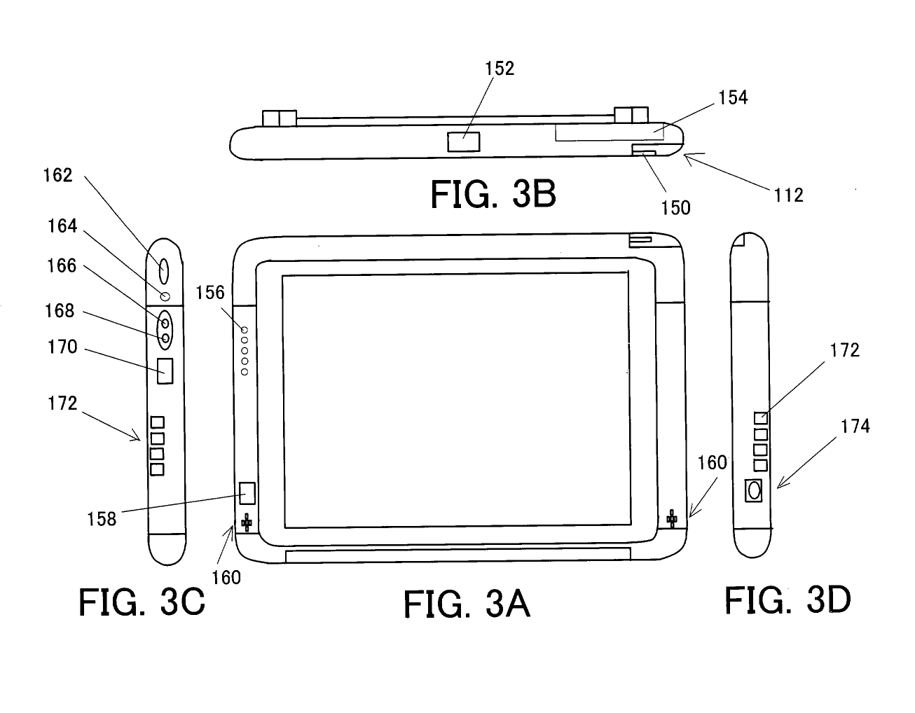

As shown in FIGS. 2 and 3, the WebPAD 100 includes an upper cover 110, a pen 150, a touch panel 122, a LCD 124, a tray 126, holder parts 128 and 130, a main board 132, an antenna cover 134, a lower cover 140, and various functional expansion units. Here, FIG. 2 is an exploded perspective view of the WebPAD 100. FIGS. 3A and 3B are, respectively, plane and top views of the WebPAD 100. FIGS. 3C and 3D are, respectively, its left and right side views.

The functional expansion unit in this embodiment includes the pen 150, a USB port 152, a radio communication antenna (or PC card) (not shown), a radio communication LAN card 154, LEDs 156, an Ir receiver part 158, a pair of speakers 160, a power switch 162, a reset switch 164, a connector for an external microphone 166, a connector for a headphone 168, an IrDA port 170, a radiator part 172, an AC adapter terminal 174, an inverter 176, and a battery part 178.

The functional expansion unit may further include a PC card, various pointing devices, a bluetooth modem, a printer connector, an interface part with a peripheral device, and a security part of the housing of the apparatus.

The “PC card” is a standard of card-type peripheral equipment for PCs that has been jointly developed by Personal Computer Memory Card International Association (“PCMCIA”) and Japan Electronic Industries Development Association (“JEIDA”). The interface part includes, but not limited to, a parallel interface (such as IEEE 1284), a serial interface (Such as IEEE 1394, RS-232C and RS-422), an IDE (such including an enhanced IDE, etc.), a SCSI (including SCSI-2 and SCSI-3, etc.), Ultra ATA, USB, ATAPI, 10BASE-2, 10BASE-T, 100BASE-TX, MIDI, ZV port, CardBus, and IrDA. The peripheral device includes, for example, but not limited to, information recording apparatuses (a MO drive, FDD, CD-ROM drive, DVD drive, LS120 drive, HDD, etc.), an expanded battery, an AC adapter, a USB connector, a PC card, a communication apparatus (including radio communication apparatuses, infrared communication apparatuses, and other communication apparatuses), a printing device (or printer, etc.), information reading apparatuses (such as a scanner and OCR, etc.), security apparatuses (such as biometric apparatuses including a fingerprint recognizer, a voice recognizer, and an iris recognizer), an imaging apparatuses (such as a digital camera and a CCD camera), a GPS device, a card reader, a barcode reader, and a cellular phone holder. For example, WebPAD 100 may download web information into an external peripheral apparatus through a SCSI connector. The security part of the housing may be biometric apparatuses such as a fingerprint recognizer, a voice recognizer, and an iris recognizer.

The upper cover 110, tray 126 and lower cover 140 are made of magnesium that has a relatively high strength, thereby making the electronic apparatus 100 small, thin and lightweight. The holder parts 128 and 130 form a grip through which a user grips the WebPAD 100, and are molded using resin having a low thermal conductivity. Use of resin that has a low thermal conductivity (for example, 0.5 W/m) for the grip would prevent a user from being subject to low-temperature burn. Resin prevents low-temperature burn as well as preventing a slip and drop of the WebPAD 100, improving the portability.

The upper cover 110 has an opening 111 at its center, exposing the touch panel 122. The upper cover 110 forms, at its upper right portion, a penholder 112 for accommodating the pen 150 used to manipulate the touch panel 122. The penholder 112 uses a pop-up mechanism that fixes the pen 150 when the pen 150 is pushed in, and ejectably releases the pen 150 when the pen 150 is pushed in again. Such a pop-up mechanism may use any structure known in the art, and a detailed description thereof will be omitted.

As shown in FIG. 3B, a card slot into which the radio LAN card 154 is ejectably inserted is provided at the side of the penholder 112 at the upper right portion of the upper cover 110 and lower cover 140. The radio LAN card 154 provides watching TV at home, a network connection to another computer, and an access to the Internet. The USB port 152 connectible with a functional expansion apparatus (such as a USB camera) to functionally expand the WebPAD 100 is provided at the center top of the upper cover 110 and lower cover 140.

The upper cover 110 and the lower cover 140 respectively include left notches 115, 141, lower notches 116 and 142, and right notches 117 and 143. The holder part 128 is engaged with right notches 117 and 143, while the holder part 130 is engaged with the left notches 115 and 141. The battery part 178 is engaged with the lower notches 116 and 142. Of course, FIG. 2 is for exemplary purposes only, and different functional expansion units may be accommodated in the upper, lower, left and right portions for enhancing multi-functionality.

The touch panel 122 indicates multiple electronic buttons for inputting information into the electronic apparatuses 100 when a user presses with his finger or the pen 150. The LCD 124 indicates various information, such as operational information, input information, and web information. The touch panel 122 and LCD 124 may use any structure known in the art, and thus a detailed description will be omitted.

The lower cover 140 accommodates a molded antenna cover 134 at its upper right portion. The antenna cover 134 protects a radio antenna (or PC card) (not shown) for communicating with an access point (not shown) and accessing the Internet. The antenna does not expose to the outside, and thus is protected from bends, snaps and damages.

As shown in FIG. 3A, the holder part 130 includes the LEDs 156 and the Ir receiver part 158. The LEDs 156 includes five lamps each for indicating a battery volume or residue, a connection status to the external power source, a radio communication status, an access status to the memory, and an error of the electronic apparatus. The Ir receiver part 158 serves as a consumer IR and communicates with a wireless keyboard, wireless pointing device, and a TV remote controller.

As shown in FIG. 3A, the holder parts 128 and 130 include the speaker 160. The speaker 160 may reproduce audio information obtained from the Internet and software installed in the WebPAD 100. The software includes, for example, a web browser, an electronic mail application, a virtual keypad for the touch panel 122, personal information manager, etc.

As shown in FIG. 3C, the power switch 162, reset switch 164, connector to the external microphone 166, connector to the headphone 168, and IrDA port 170 are provided at the left side of the holder part 130. The power switch 162 is a switch used to power on and off the WebPAD 100. The reset switch 164 is a switch used to restart the WebPAD 100. The connector to the external microphone 166 is a connector connectible to the external microphone terminal. The connector to the headphone 168 is a connector connectible to the headphone terminal to transmit to the headphone voices rather than outputting the voices from the speaker 160. The IrDA port 170 is a port for infrared communications. IrDA conceptually includes IrTran-P to tranfer images through infrared rays between a digital camera and a PC or portable information terminal.

As shown in FIGS. 3B and 3D, the radiator part 172 is provided at the holder parts 128 and 130, and equipped with four openings (air ducts) and a fan in the inside (not shown). A housing of the conventional WebPAD cannot be equipped with a fan when seeking for a low profile, but the WebPAD 100 may be equipped with the fan because it has the thicker periphery 104, enhancing its heat radiation efficiency and preventing thermal breakdown of internal electronic circuits.

As shown in FIG. 3D, the connector 174 for the AC adapter is provided at the right side of the holder part 128, and the inverter 176 is provided in the holder part 128. The connector for the AC adapter 174 is used to drive the WebPAD 100 with an external power source, and the inverter 176 is used as the backlight of the LCD 124. The inverter 176 may use a piezoelectric type, for example.

One embodiment forms part or all of the holder part detachably so that the detached part may serve as a telephone handset. The digital camera and telephone functions enable the WebPAD 100 to serve as a videophone, enhancing the multi-functionality. In another embodiment, the holder part serves as a card reader. The card is not limited to a magnetic card, such as a credit card, but may include a contact/non-contact IC card, a memory card, and other expansion cards. Therefore, the card reader conceptually covers a reader/writer for storing the electronic money into the IC card. In still another embodiment, there are multiple types of peripheries 104 and holder parts 128 and 130, and the WebPAD 100 is made by incorporating desired members selected from them. For example, a user who requests for use of a videophone may use a holder part having a telephone function rather than the holder part 128 shown in FIG. 2. Such an option would provide a lightweight effect to a user who does not need that function and the multi-functionality to a use who needs that function.

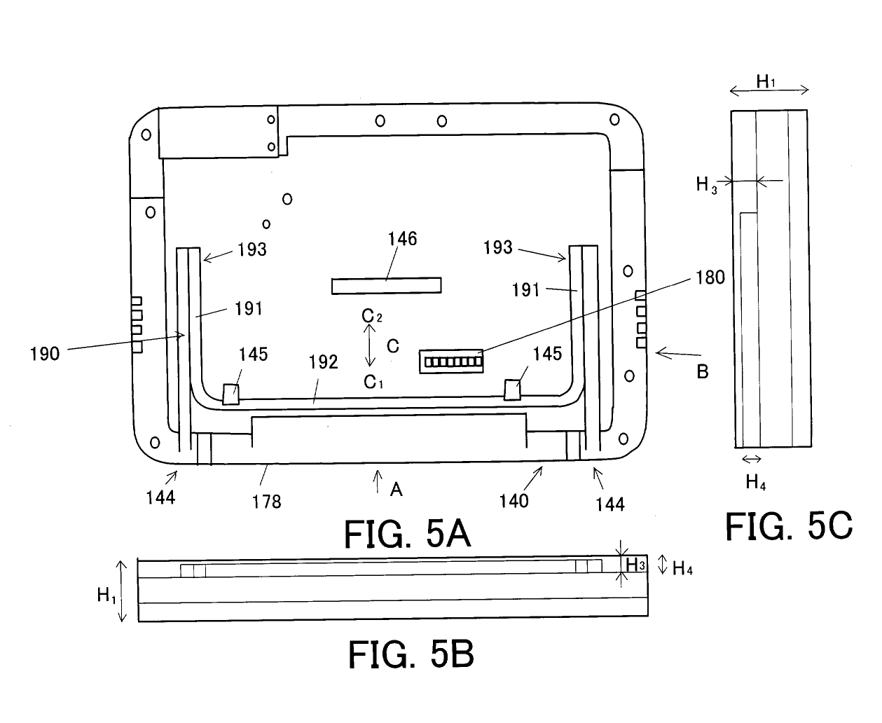

As discussed with reference to FIG. 2, the battery part 170 is engaged with the lower notch 116 in the upper cover 110 and the lower notch 142 in the lower cover 140. The battery part 178 accommodates a battery as a power source in a case made of magnesium. Such a battery is a rechargeable secondary battery, and the WebPAD 100 has a connection part connectible to a charger (or cradle) for charging the battery, at a rear surface of the center part 102, as described with reference to FIG. 5.

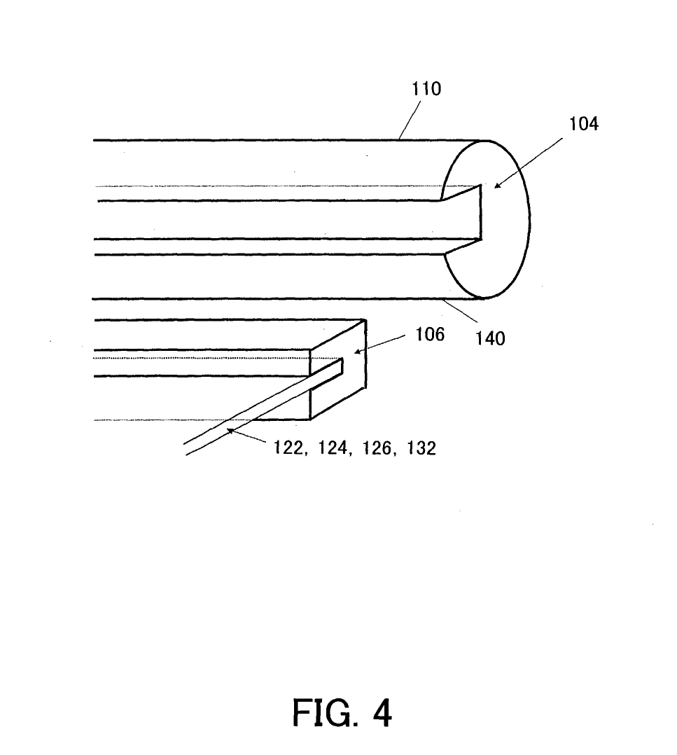

As shown in FIG. 4 although omitted in FIG. 2, it is preferable to provide a shock absorbing member 106 between the pipe-shaped periphery 104 and the electronic circuit (including the touch panel 122, LCD 124, tray 126, and main board 132) to reduce shock applied to the electronic circuit. Here, FIG. 4 is a schematic perspective view of the shock absorbing member 106. The shock absorbing member 106 has an approximately U-shaped section to hold the electronic circuit, and is engaged with the approximately U-shaped section in the periphery 104. The shock absorbing member 106 is made, for example, of rubber, but may use any material, shape, etc. as far as it absorbs an impact and vibration and fits the inside of the periphery 104. It is possible to reduce impacts applied to the WebPAD 100 and protecting the electronic circuit from damages by using a pipe-shaped cave in the periphery 104 to fix the shock absorbing member 106 and fixing the electronic circuit in the shock absorbing member 106.

Referring now to FIG. 5, a description will be given of a rear surface of the WebPAD 100. Here, FIG. 5A is a rear view of the WebPAD 100, and FIG. 5B is a schematic plane view that is partially transparent and viewed from a direction A in FIG. 5A. FIG. SC is a schematic plane view that is partially transparent and viewed from a direction B in FIG. 5A.

As shown in FIG. 5, the connection part 180, which is connectible to the charger (or cradle) (not shown) for charging the battery, is provided at the rear surface of the lower cover 140.

The WebPAD 100 includes a stand mechanism 190 for inclining and placing the WebPAD 100 on a desk. Thereby, the WebPAD 100 is suitable for use on a desk. Of course, stand mechanisms applicable to the present invention are not limited to the stand mechanism 190, and may use, for example, tilt legs that may be accommodated and projected in the holder parts 128 and 130. In addition, the present invention enables the WebPAD 100 to be detachably mounted on an optional support rack as a separate member.

The stand mechanism 190 includes a pair of rotary parts 191 and a support part 192. The rotary parts 191 have an approximately straight shape and are rotatably provided, as shown in FIG. 5A, on a stand hinge 144 of the lower cover 140. The support part 192 has an approximately U-shape and is rotatably attached to the rotary parts 191 through a pair of connection parts 193. The support part 192 has a pair of engagement grooves 192a each engageable with a lock part 145, which will be described later.

The stand mechanism 190 may be folded and unfolded, and FIG. 5A shows the folded stand mechanism 190. In the folded state, the support part 192 in the stand mechanism 190 is secured by a pair of lock parts 145 provided on the lower cover 140. The lock parts 145 fix the stand mechanism 190 when it is not used and prevent its unfolding so that the stand mechanism 190 does not contact the external member and break when it is not used.

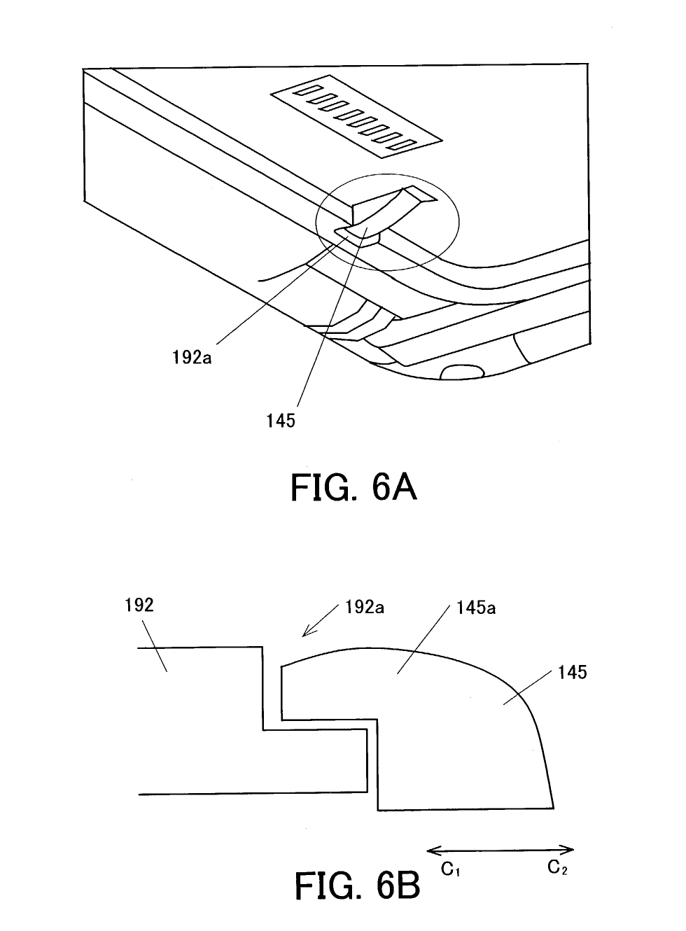

The lock parts 145 are movable in the direction C and forced in a direction C₁. As shown in FIGS. 5A and 6, the lock part 145 has a curved surface in the direction C. Here, FIG. 6A is a partially enlarged perspective view of the vicinity of the lock parts 145. FIG. 6B is its partially enlarged sectional view. When a user presses the support parts 192 with his finger towards the lower cover 140, the bottom of the engagement groove 192a pushes and moves the lock parts 145 back in a direction C₂ and allows the support part 192 to contact the lower cover 140. Thereafter, an engagement part 145a at the tip of the lock part 145 forced in the direction C₁ engages with the engagement groove 192a and locks the support part 192.

FIGS. 5B and 5C show that the height H₄ of the stand mechanism 190 is lower than the height H₃ of the lower cover 140 when viewed from the LCD 124 where the stand mechanism 190 is folded. In other words, when the WebPAD 100 is viewed in the directions A and B in FIG. 5A, the stand mechanism 190 is invisible and thus the stand mechanism 190 does not prevent the WebPAD 100 from being made thin. Thus, this embodiment maximize the space defined by a difference of height between the lower cover 140 and the center part 102 (i.e., H₃-H₄).

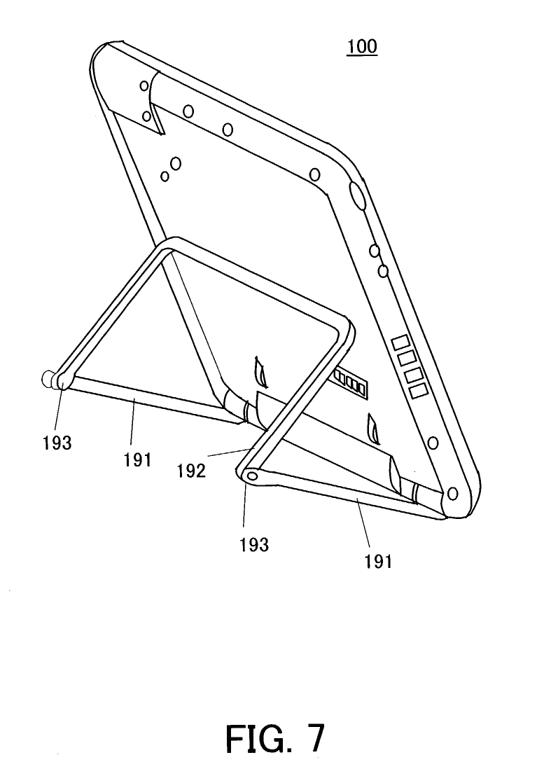

In order to unlock the support part 192 from the lock parts 145, a user moves the lock parts 145 in the direction C₂ with his finger, and raises the support part 192 from the lower cover 140. Then, the standing support part 192 is rotated around the connection part 193, and held by a stand holder part 146 formed on the lower cover 140. The held support part 192 supports the housing 101. FIG. 7 shows this state. As shown in FIG. 7, the WebPAD 100 may maintain its inclined posture on the desk when the stand holder part 146 holds the support part 192.

Further, the present invention is not limited to these preferred embodiments, and various modifications and variations may be made without departing from the spirit and scope of the present invention.

Thus, the inventive electronic apparatus may provide a portable electronic apparatus in pursuit of miniaturization, low profile, lightweight property, and multi-functionality as well as improved portability and shock resistance.

What is claimed is:

1. A portable electronic apparatus comprising:
a display part which displays information; and
an approximately pipe-shaped protective part, provided around and thicker than said display part, which protects said display part by positioning said display part at a depressed portion from said protective part.

2. A portable electronic apparatus according to claim 1, further comprising a shock absorbing member, provided between said display part and said protective part, which reduces a shock applied to said display part.

3. A portable electronic apparatus according to claim 1, wherein said protective part includes:
a base made of a first material; and
a grip made of a second material that has a thermal conductivity lower than the first material.

4. A portable electronic apparatus according to claim 3, wherein the first material includes magnesium.

5. A portable electronic apparatus according to claim 3, wherein the second material includes resin.

6. A portable electronic apparatus comprising:
a display part which displays information;
a protective part, provided around and thicker than said display part, which protects said display part by positioning said display part at a depressed portion from said protective part; and
a functional expansion unit, accommodated in said protective part, which expands a function of the electronic apparatus.

7. A portable electronic apparatus according to claim 6, further comprising a shock absorbing member, provided between said display part and said protective part, which reduces a shock applied to said display part.

8. A portable electronic apparatus according to claim 6, wherein said protective part includes:
a base made of a first material; and
a grip made of a second material that has a thermal conductivity lower than the first material.

9. A portable electronic apparatus according to claim 8, wherein the first material includes magnesium.

10. A portable electronic apparatus according to claim 8, wherein the second material includes resin.

11. A portable electronic apparatus according to claim 6, wherein the functional expansion unit includes a radio communication part.

12. A portable electronic apparatus according to claim 6, wherein the functional expansion unit includes an electronic imaging part.

13. A portable electronic apparatus according to claim 6, wherein the functional expansion unit serves as a telephone.

14. A portable electronic apparatus according to claim 6, wherein the functional expansion unit serves as an electronic imaging part and a telephone so as to enable the electronic apparatus to serve as a videophone.

15. A portable electronic apparatus according to claim 6, wherein the functional expansion unit includes a stand that inclines and places the display part on a desk.

16. A portable electronic apparatus according to claim 15, wherein the stand is provided rotatable relative to said protective part, and said electronic apparatus further comprises a holder that engages with and fixing the stand.

17. A portable electronic apparatus according to claim 15, wherein the stand is provided foldable relative to said protective part, and said electronic apparatus further comprises a lock part that fixes the stand folded.

18. A portable electronic apparatus according to claim 17, wherein the stand folded is placed partially on said display part, and the height of the stand viewed from said display part is lower than said protective part.
